(19) United States
(12) Patent Application Publication
(10) Pub. No.: US 2018/0130496 A1
(43) Pub. Date: May 10, 2018

(54) METHOD AND SYSTEM FOR AUTO-GENERATION OF SKETCH NOTES-BASED VISUAL SUMMARY OF MULTIMEDIA CONTENT

(71) Applicant: YEN4KEN, INC., Princeton, NJ (US)

(72) Inventors: Jyotirmaya Mahapatra, Jajpur (IN); Fabin Rasheed, Alleppey (IN); Kundan Shrivastava, Bangalore (IN); Nimmi Rangaswamy, Medak (IN)

(21) Appl. No.: 15/346,014

(22) Filed: Nov. 8, 2016

(51) Int. Cl. G11B 27/031; G11B 27/10; G10L 15/26; G06K 9/62

(52) U.S. Cl. CPC G11B 27/031; G06K 9/6202; G10L 15/265; G11B 27/10

(57) ABSTRACT

The disclosed embodiments illustrate method and system for auto-generation of the sketch notes-based visual summary of the multimedia content. The method includes determining one or more segments, based on one or more transitions in the multimedia content. The method further includes generating a transcript based on audio content associated with each determined segment. The method further includes retrieving a set of images from an image repository based on each of the identified one or more keywords. The method further includes generating a sketch image of each of one or more of the retrieved set of images associated with each of the identified one or more keywords. The method further includes rendering the sketch notes-based visual summary of the multimedia content, generated based on at least generated one or more sketch images, on a user interface displayed on a display screen of the user-computing device.

### TECHNICAL FIELD

The presently disclosed embodiments are related, in general, to multimedia content processing. More particularly, the presently disclosed embodiments are related to a method and a system for the auto-generation of a sketch notes-based visual summary of multimedia content.

### BACKGROUND

The past decade has witnessed various advancements in the field of information and web technologies for providing an enriched consumption experience of multimedia content, such as technology, entertainment, and design (TED)-like slide-based informational and general lecture videos, and open education resources (OERs), to end users, such as learners. Numerous techniques, including visual summarization, have been developed to provide a quick summary of multimedia content to users. Typically, visual summaries of the multimedia content are designed and created by using quick reference tools, such as sketch-notes.

Generally, sketch-notes are prepared manually by sketch-note authors who possess specialized skills, such as creative sketching and versatile visual vocabulary. In certain scenarios, as the visual summarization of the multimedia content depends heavily on the expertise of sketch-note authors, there is a chance of missing some important events in the course or length of the talk. Such visual summaries may appear to be unstructured and thus, difficult to understand for end users. In other scenarios, the visual summarization of the multimedia content depends on other factors, such as scaling of imagery based on visual importance in the multimedia content, semantic significance levels of key frames, and the like. The dependence of the visual summarization of the multimedia content on the aforesaid factors may be problematic as the visual summary thus created may not provide an enriching and effective multimedia consumption experience to the end users. In other scenarios, the sketch-notes are perceived to be lot more fun than being serious by and large created for a conference audience to serve as a reference and talking point. However, people who have not attended the talk may not carry forward much elaborate meaning from the sketch-notes. To overcome the aforesaid problems, an automated and efficient system and method is required for the auto-generation of a structured and organic sketch-notes-like visual summary of the multimedia content.

Further limitations and disadvantages of conventional and traditional approaches will become apparent to a person with ordinary skill in the art, through a comparison of described systems with some aspects of the present disclosure, as set forth in the remainder of the present application and with reference to the drawings.

### SUMMARY

According to embodiments illustrated herein, there may be provided a method for auto-generation of sketch notes-based visual summary of multimedia content. The method includes determining, by a pre-processing engine of an application server, one or more segments of the multimedia content, received from a user-computing device over a communication network, based on one or more transitions in the received multimedia content. The method further includes generating, by the pre-processing engine at the application server, a transcript based on audio content associated with each determined segment. The method further includes retrieving, by the pre-processing engine at the application server, a set of reference images, pertaining to each of one or more keywords identified from one or more key phrases in the generated transcript, from a reference image repository based on each of the identified one or more keywords. The method further includes generating, by the pre-processing engine at the application server, a sketch image of each of one or more of said retrieved set of reference images associated with each of the identified one or more keywords. The method further includes rendering, by a sketch note compiler at the application server, the sketch notes-based visual summary of the multimedia content, generated based on at least generated one or more sketch images associated with the determined one or more segments of the multimedia content, on a user interface displayed on a display screen of the user-computing device.

According to embodiments illustrated herein, there may be provided a system for auto-generation of sketch notes-based visual summary of multimedia content. The system includes a pre-processing engine of an application server configured to determine one or more segments of the multimedia content, received from a user-computing device over a communication network, based on one or more transitions in the received multimedia content. The pre-processing engine at the application server is further configured to generate a transcript based on audio content associated with each determined segment. The pre-processing engine at the application server is further configured to retrieve a set of reference images, pertaining to each of one or more keywords identified from one or more key phrases in the generated transcript, from a reference image repository based on each of the identified one or more keywords. The system further includes a sketch note compiler at the application server configured to render sketch notes-based visual summary of the multimedia content, generated based on at least generated one or more sketch images associated with the determined one or more segments of the multimedia content, on a user interface displayed on a display screen of the user-computing device.

According to embodiments illustrated herein, there may be provided a computer program product for use with a computing device. The computer program product comprises a non-transitory computer readable medium storing a computer program code for auto-generation of sketch notes-based visual summary of multimedia content. The computer program code is executable by one or more processors to determine one or more segments of the multimedia content, received from a user-computing device over a communication network, based on one or more transitions in the received multimedia content. The computer program code is further executable by the one or more processors to generate a transcript based on audio content associated with each determined segment. The computer program code is further executable by the one or more processors to retrieve a set of reference images, pertaining to each of one or more keywords identified from one or more key phrases in the generated transcript, from an image repository based on each of the identified one or more keywords. The computer program code is further executable by the one or more processors to generate a sketch image of each of one or more of the retrieved set of reference images associated with each of the identified one or more keywords. The computer program code is further executable by the one or more processors to render sketch notes-based visual summary of the multimedia content, generated based on at least generated one or more sketch images associated with the determined one or more segments of the multimedia content, on a user interface displayed on a display screen of the user-computing device.

### BRIEF DESCRIPTION OF DRAWINGS

The accompanying drawings illustrate the various embodiments of systems, methods, and other aspects of the disclosure. A person having ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system environment in which various embodiments can be implemented, in accordance with at least one embodiment;

FIG. 2 is a block diagram that illustrates a system for the auto-generation of a sketch notes-based visual summary of multimedia content, in accordance with at least one embodiment;

FIGS. 3A and 3B collectively depict a flowchart that illustrates a method for the auto-generation of a sketch notes-based visual summary of multimedia content, in accordance with at least one embodiment;

FIG. 4 is a block diagram that illustrates a pre-defined object model for the auto-generation of a sketch notes-based visual summary of multimedia content, in accordance with at least one embodiment;

FIGS. 5A, 5B, and 5C collectively illustrate an exemplary workflow for the auto-generation of a sketch notes-based visual summary of multimedia content, in accordance with at least one embodiment; and

FIG. 6 illustrates an exemplary snapshot depicting a sketch notes-based visual summary of multimedia content at the user interface of a user-computing device, in accordance with at least one embodiment.

### DETAILED DESCRIPTION

The present disclosure may be best understood with reference to the detailed figures and description set forth herein. Various embodiments are discussed below with reference to the figures. However, those skilled in the art would readily appreciate that the detailed descriptions given herein with respect to the figures are simply for explanatory purposes, as the method and system may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the respective meanings set forth below:

A “user-computing device” refers to a computer, a device (that includes one or more processors/microcontrollers and/or any other electronic components), or a system (that performs one or more operations according to one or more sets of programming instructions, codes, or algorithms) associated with a user. In an embodiment, the user may utilize the user-computing device to transmit a uniform resource locator (URL) of multimedia content (e.g., a video clip) to an application server over a communication network. Further, the user may utilize the user-computing device to provide his/her preferences as one or more input parameters via the user-computing device. Examples of the user-computing device may include, but are not limited to, a desktop computer, a laptop, a personal digital assistant (PDA), a mobile device, a smartphone, and a tablet computer (e.g., iPad® and Samsung Galaxy Tab®).

“Multimedia content” refers to a combination of different content forms, such as text content, audio content, image content, animation content, video content, and/or interactive content, in a single file. In an embodiment, the multimedia content may be reproduced on a computing device, such as the user-computing device, through an application, such as a media player (e.g., Windows Media Player®, Adobe® Flash Player, Apple® QuickTime®, and/or the like). In an embodiment, the multimedia content may be downloaded from a content server to the user-computing device. In an embodiment, the application server may download the multimedia content from the content server, by means of a URL provided by the user-computing device. In an alternate embodiment, the multimedia content may be retrieved from a media storage device, such as hard disk drive (HDD), CD drive, pen drive, and/or the like, connected to (or within) the user-computing device.

A “transcript” refers to an electronic document that may be generated by converting the verbal and/or audio stream of the multimedia content into machine-readable text format, by a user of one or more speech-to-text conversion techniques and/or tools, known in the art. Further, the text transcript, thus obtained, may be displayed on a computing device in synchronization with the audio-visual streaming of the multimedia content. Transcripts of the verbal and/or audio streams, such as court hearings in legal trials and physicians' voice-notes, may be generated to be used in different application areas, such as legal and medical purposes.

A “segment” corresponds to a portion of multimedia content that corresponds to a topic within the multimedia content. In an embodiment, for an audio transcript wherein each word in the text corresponds to a timestamp, the segment corresponds to a paragraph of the text with a beginning and an ending timestamp. In another embodiment, when the paragraph timestamp is not known, the segment is identified by the use of image processing techniques based on slide transitions, indicating a change in context of the discussion, in the visual stream. Typically, the duration of the multimedia segment within the multimedia content is less than or equal to the duration of the multimedia content.

“One or more key phrases” correspond to one or more salient combinations of a plurality of keywords in each multimedia segment within a multimedia content. In an embodiment, each key phrase in the one or more key phrases may represent the context of a topic being presented in the multimedia segment. In an embodiment, the one or more key phrases may be determined based on a degree of importance of one or more words in the generated transcript.

“One or more keywords” refer to a set of salient words, which are not stop words (such as “a,” “an,” and “of”), in each of one or more key phrases associated with one or more text frames of multimedia content. In an embodiment, the one or more keywords may be identified from the one or more key phrases based on a frequency of occurrence of the one or more keywords in the one or more key phrases in one or more segments.

A “reference image repository” refers to a collection of a plurality of reference images. In an embodiment, each image from the plurality of reference images in the reference image repository may be tagged with one or more keywords. In an embodiment, the reference image repository may be stored locally in the use-computing device. In another embodiment, the reference image repository may be stored remotely in a database server.

A “sketch image” refers to an image generated from a retrieved set of reference images from the reference image repository. In an embodiment, the reference images associated with each of the identified one or more keywords are retrieved and the sketch images are generated. The generation of the sketch images is based on the two-layer processing of the reference images. The first layer processing applies threshold on the reference image and provides two sets of colors, major color and minor color, to the reference image. Thereafter, a pattern may be overlaid on the major color. The second layer processing obtains image edges by Sobel Edge Detection known in the art. Accordingly, a darker color may be assigned to the edges of the reference image. The output of the first and the second layer processing is combined to obtain a final sketchy reference image. Such two-layer processing is done using pre-specified scripts, such as ProceessingJS, being run on a third-party web server. The processed reference images are stored at the user-computing device, which can later be fetched by the application server for generating a sketch notes-based visual summary of multimedia content.

A “sketch cell” refers to sketch representations of each segment in the multimedia content. Once a plurality of sketch cells are identified, sketch cell anchor points may be computed such that they may be overlaid on a pre-defined template. Thereafter, the plurality of sketch cells may be rendered as a sketch notes-based visual summary based on a pre-defined object model with key entities of sketch images, a sketch title phrases, and one or more sketch keywords associated with the sketch images. The count of sketch cells corresponds to count of segments in the multimedia content.

A “pre-defined template” refers to a fixed structure (pre-defined coordinates) pre-specified by a user to define the logical structure of a sketch notes-based visual summary of multimedia content. The one or more pre-defined templates may also be referred to as sketch templates. In an embodiment, the pre-defined templates may be dynamically modified by the user. Various structures of the pre-defined template may correspond to fluidic, organic, and linear structures.

“One or more first frames” refer to image frames associated with one or more first events that correspond to a single picture or a still shot that is part of multimedia content (e.g., a video). The multimedia content is usually composed of a plurality of frames that is rendered, on a display device, in succession to appear as a seamless piece of the multimedia content. In an embodiment, a frame in the multimedia content corresponds to at least an event.

“One or more second frames” refer to image frames (associated with one or more second events) that occur after the one or more first frames (associated with one or more first events). For example, a set of first frames may be associated with a first event, such as a first presentation by a first instructor in a lecture video. Once the first instructor finishes the first presentation, a second instructor continues the lecture video and initiates a second presentation, associated with one of the topics in the first presentation. In such a case, the second presentation corresponds to a second event and associated with a set of second frames.

“One or more transitions” correspond to a set of time stamps in a multimedia content that may represent a change in context of topic being presented in the multimedia content. In other words, a transition in the multimedia content corresponds to switching from one or more first events associated with one or more first frames in the multimedia content to one or more second events associated with one or more second frames in the multimedia content. In an embodiment, the one or more transitions may be determined based on audio cues or visual cues.

A “sketch notes-based visual summary” corresponds to a summarized, structured, and organic graphical representation of a specific multimedia content, such as TED-like informational or general lecture videos. Such a graphical representation may correspond to sketch-based abstraction called sketch cells, which also consist of supporting text and key phrases. Such a sketch notes-based visual summary further enables users to customize, edit the tool-generated summary from the multimedia content, allows video navigation from summaries, and quick referencing or future concept revisions. The design and formatting of a sketch notes-based visual summary may leverage chronological, relational, and image properties of concepts discussed in the multimedia content by an optimized arrangement of sketch cells in a generated sketch template.

“A degree of importance of one or more words” refers to saliency of each keyword in a plurality of keywords (determined from multimedia content). In an embodiment, the degree of importance may be computed by one or more known techniques that may be utilized to assign a saliency score to each of the plurality of keywords. Examples of such techniques may include, but are not limited to, a Text Rank technique, a PageRank technique, and the like.

“Normalization” refers to the stemming of one or more stop words that may be performed using third-party tools, such as Porter Stemmer, Stemka, and the like. Examples of such stop words may include articles, conjunctions, pronouns, prepositions, and the like among the plurality of keywords.

“Frequency of occurrence of keywords” refers to a count of instances that may be identified by a text processing algorithm in one or more portions of an audio transcript. For example, for a video segment, count of instances of a keyword “human behavior” is “50.” In this case, “50” corresponds to the frequency of occurrence of the keyword “human behavior.”

“A pre-defined object model” refers to a hierarchal object model that allows for efficient creation, rendering, customizing and manipulation of sketch elements through sketch cells in run-time at a user interface of a user-computing device. The pre-defined object model encompasses the structure of the sketch notes-based visual summary and its relational and chronological attributes.

“One or more input parameters” refer to input preferences based on which the sketch notes-based visual summary may be customized by a user. The one or more input parameters may be provided by the user to update the generated sketch notes-based visual summary. Such an update of the sketch notes-based visual summary may include the addition of sketch elements, text and screenshots, freehand overlay drawing, navigation through multimedia content, and accessing visual vocabulary.

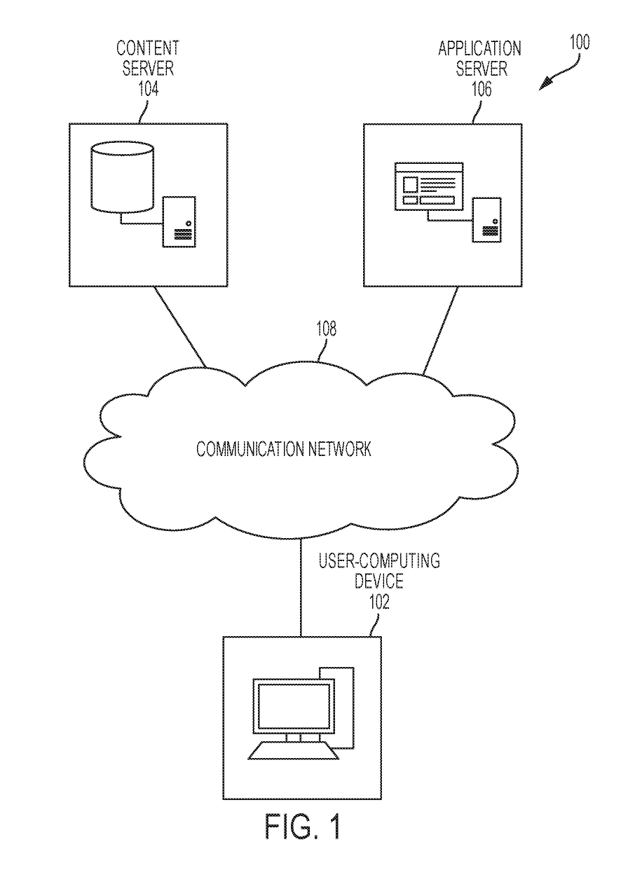

FIG. 1 is a block diagram of a system environment in which various embodiments of a method and a system for the auto-generation of a sketch notes-based visual summary of multimedia content may be implemented, in accordance with at least one embodiment. With reference to FIG. 1, a system environment 100 is shown that includes various devices, such as a user-computing device 102, a content server 104, and an application server 106. Various devices in the system environment 100 may be interconnected over a communication network 108. FIG. 1 shows, for simplicity, one user-computing device (such as the user-computing device 102), one content server, (such as the content server 104), and one application server (such as the application server 106). However, it will be apparent to a person with ordinary skill in the art that the disclosed embodiments may also be implemented using multiple user-computing devices, multiple content servers, and multiple application servers without departing from the scope of the disclosure.

The user-computing device 102 may refer to a computing device (associated with a user) that may be communicatively coupled to other devices over the communication network 108. The user-computing device 102 may include one or more processors in communication with one or more memory units. Further, in an embodiment, the one or more processors may be operable to execute one or more sets of computer-readable code, instructions, programs, or algorithms, stored in the one or more memory units, to perform one or more operations.

The user-computing device 102 may be associated with a user such as a student associated with an academic institute or an employee (e.g., a content analyst) associated with an organization. The user may utilize the user-computing device 102 to transmit a request to the application server 106 over the communication network 108. The request may correspond to the auto-generation of the sketch notes-based visual summary of multimedia content. In an embodiment, the user may utilize input devices associated with the user-computing device 102 to select the desired multimedia content from the content server 104 (e.g., YouTube®). For the selection of the desired multimedia content, the user may utilize input devices associated with the user-computing device 102 to transmit a uniform resource locator (URL) to the application server 106 over the communication network 108. Further, the user may utilize the input devices associated with the user-computing device 102 to provide one or more input parameters to update the sketch notes-based visual summary (of the multimedia content) generated by the application server 106. The update may correspond to addition, deletion, and/or modification of the sketch cells in the generated sketch notes-based visual summary. Examples of the input devices include, but are not limited to, a keyboard, a mouse, a joystick, a touch screen, a microphone, a camera, and/or a docking station.

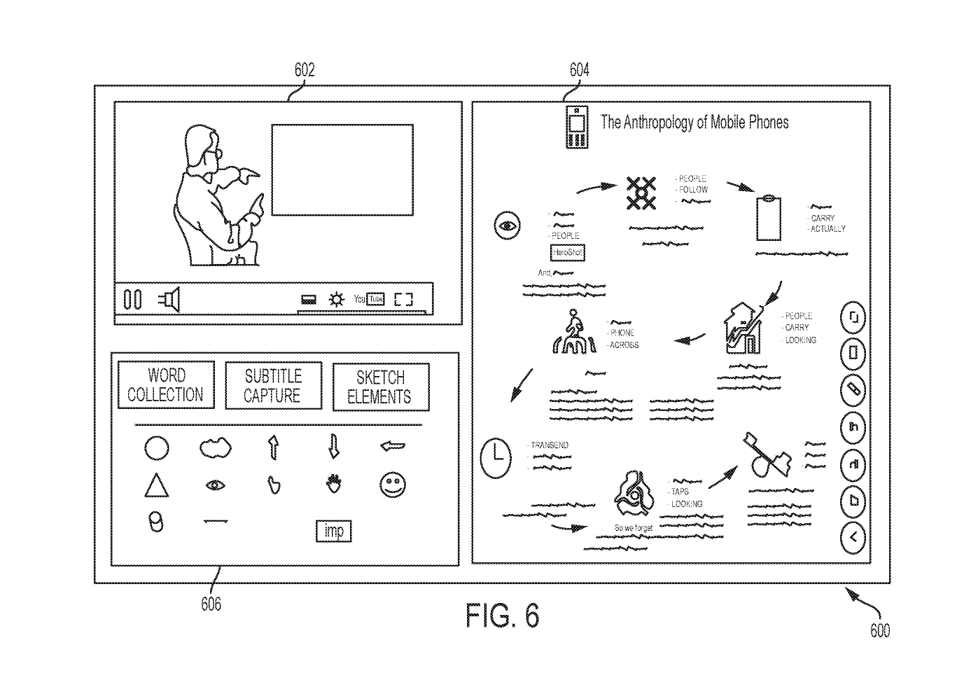

In an embodiment, the user may utilize output devices, such as a display screen, associated with the user-computing device 102 to view the sketch notes-based visual summary of the multimedia content rendered by the application server 106 over the communication network 108. The display screen of the user-computing device 102 may present a user interface that includes at least three display sections, as described hereinafter in detail in FIG. 6. The first display section may include a multimedia content player that displays the multimedia content streamed by the content server 104. The second display section may include a sketch control section that includes word collection, captured subtitles, and a sketch element component library. The third display section may include a viewer or an editor that displays the sketch notes-based visual summary rendered by the application server 106 over the communication network 108. Examples of the output devices include, but are not limited to, a display screen and/or a speaker.

The user-computing device 102 may include one or more installed applications (e.g., Windows Media Player®, Adobe® Flash Player, Apple® QuickTime®, and/or the like) that may support the online or offline playback of the multimedia content streamed by the content server 104 over the communication network 108. Examples of the user-computing device 102 may include, but are not limited to, a personal computer, a laptop, a PDA, a mobile device, a tablet, or other such computing device.

The content server 104 may refer to a computing device or a storage device that may be communicatively coupled to other devices over the communication network 108. In an embodiment, the content server 104 stores one or more sets of instructions, code, scripts, or programs that may be executed to perform the one or more operations. Examples of the one or more operations may include receiving/transmitting one or more queries, requests, multimedia content, or input parameters from/to one or more computing devices (such as the user-computing device 102), or one or more application servers (such as the application server 106). The one or more operations may further include processing and storing the one or more queries, requests, multimedia content, or input parameters. For querying the content server 104, one or more querying languages, such as, but not limited to, SQL, QUEL, and DMX, may be utilized.

In an embodiment, the content server 104 may pre-store multimedia content and the corresponding URL for which the sketch notes-based visual summary is generated by the application server 106. The content server 104 may be further configured to store the audio transcript of the multimedia content that may be transmitted to the application server 106 over the communication network 108. In an embodiment, the content server 104 may be realized through various technologies, such as, but not limited to, Microsoft® SQL Server, Oracle®, IBM DB2®, Microsoft Access®, PostgreSQL®, MySQL®, and SQLite®.

A person having ordinary skill in the art will appreciate that the scope of the disclosure is not limited to realizing the content server 104 and the user-computing device 102 as separate entities. In an embodiment, the one or more functionalities of the content server 104 may be integrated into the user-computing device 102 or vice-versa, without departing from the scope of the disclosure.

The application server 106 refers to a computing device or a software framework hosting an application or a software service that may be communicatively coupled to other devices, such as the user-computing device 102 and the content server 104, over the communication network 108. In an embodiment, the application server 106 may be implemented to execute procedures, such as, but not limited to programs, routines, or scripts stored in one or more memory units for supporting the hosted application or the software service. In an embodiment, the hosted application or the software service may be configured to perform the one or more operations. In an embodiment, the one or more operations may include the processing of the multimedia content for auto-generation of the sketch notes-based visual summary.

In an embodiment, the application server 106 may receive a request from the user-computing device 102 over the communication network 108 to generate the sketch notes-based visual summary of the multimedia content. The application server 106 may perform a check to determine whether the received request comprises only URL. If it is determined that the received request comprises the URL, the application server 106 may retrieve the multimedia content (corresponding to the URL in the received request) from the content server 104, over the communication network 108. Otherwise, in response to the request, the application server 106 may directly retrieve sketch cell titles, sketch cell keywords, and a set of sketch images from a web server or the user-computing device 102 over the communication network 108. In such an embodiment, the sketch cell titles, sketch cell keywords, and a set of sketch images may be determined by a pre-processing engine at the web server or the user-computing device 102. Thereafter, the application server 106 may proceed with the sketch cell compilation.

In an embodiment, in case the received request comprises the URL, the application server 106 may be configured to perform a check to determine whether the retrieved multimedia content comprises an audio transcript. If it is determined that the retrieved multimedia content comprises the audio transcript, the application server 106 may identify beginning and ending timestamps of each paragraph in the audio transcript of the multimedia content. Thereafter, the application server 106 proceeds with the determination of one or more transitions in the audio and/or video stream of the multimedia content.

However, if it is determined that the retrieved multimedia content does not comprise the audio transcript, the application server 106 may perform a check to determine whether specific library routines or automatic speech recognition (ASR) algorithm for the extraction of the audio transcript are available in the memory 204. In case it is determined that the specific library routines or ASR algorithm for extraction of the audio transcripts are available, then the application server 106 may execute the determined specific library routines or ASR algorithm to determine the timestamps mapped to each word in the text. Further, the application server 106 may identify beginning and ending timestamps of each paragraph in the audio transcript of the multimedia content.

The application server 106 may further determine the one or more transitions in the audio and/or video stream of the multimedia content. Based on the determined one or more transitions, the application server 106 may determine one or more segments of the multimedia content. The application server 106 may further extract one or more key phrases from the generated one or more segments using one or more library routines, thereby identifying sketch titles for each of the one or more segments.

Thereafter, the application server 106 may identify the one or more keywords from the one or more key phrases. In an embodiment, the application server 106 may identify the pre-specified number of top keywords from the one or more identified keywords based on the frequency of occurrence of the one or more keywords in the extracted one or more key phrases. In an embodiment, the application server 106 may normalize the extracted one or more keywords in the generated transcript to eliminate one or more stop words, thereby identifying sketch keywords for each of the one or more segments.

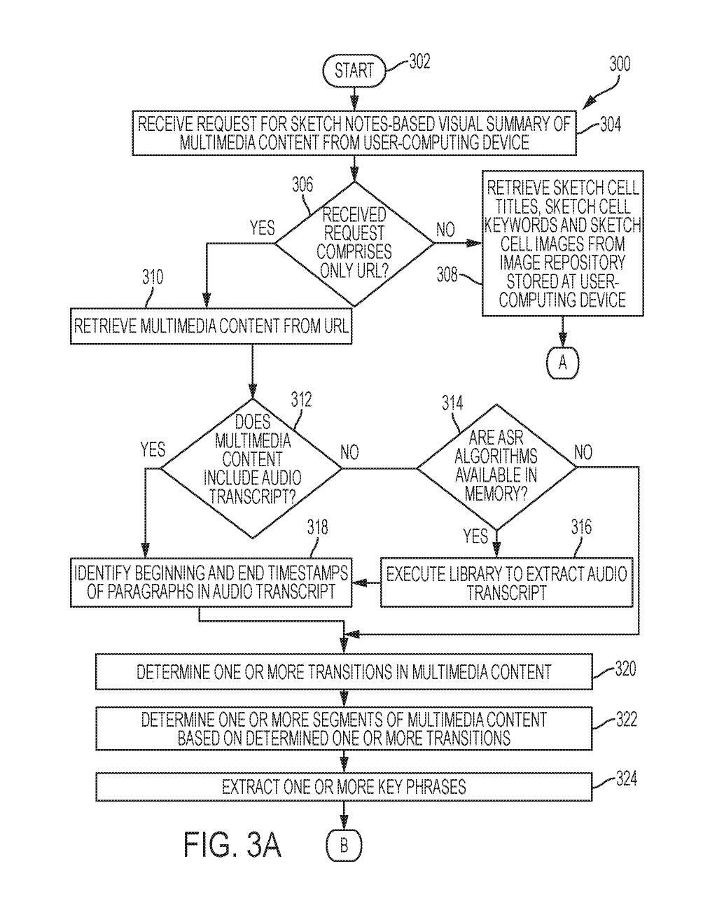

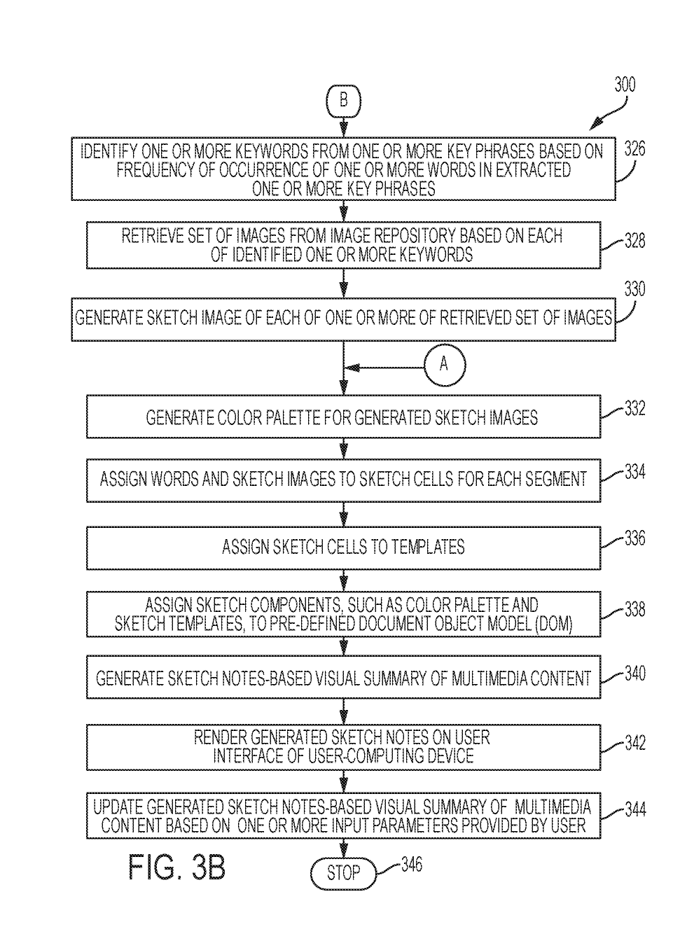

In an embodiment, the application server 106, in conjunction with a custom search and/or one or more application programming interface (APIs), may be configured to retrieve a set of reference images from reference image repository based on each of the identified one or more keywords in each of the determined one or more segments. The retrieval of the set of reference images has been explained later in detail in conjunction with FIGS. 3A and 3B.

In an embodiment, the application server 106 may be configured to generate the sketch image of each of the identified pre-specified number of top reference images. Thereafter, the application server 106 may perform a first layer processing to threshold the pre-specified number of top reference images and provide two sets of colors. Thereafter, the application server 106 may perform a second layer processing to obtain image edges by utilizing one or more edge detection techniques, such as the Sobel edge detection technique. Thereafter, the application server 106 may overlay the obtained image edges over the layer generated through the first layer processing to generate the finalized sketch images, thereby identifying sketch images for each of the one or more segments.

In an alternative embodiment, the sketch images may be generated by one or more dynamic scripts, such as ProceessingJS, being executed on the web server. In such a case, the web server may store the set of sketch images in a specific format, such as SVG format, at the client side, such as the user-computing device 102, which may be later-on retrieved at run-time by the application server 106.

In an embodiment, for the retrieved sketch images, the application server 106 may be configured to generate a color palette for each of the set of sketch images. The application server 106 may be further configured to assign a pre-defined layout, i.e., a sketch template, to the sketch cells. The application server 106 may be further configured to assign the sketch titles, sketch keywords, and sketch images to the sketch cells. The application server 106 may be further configured to assign the sketch cells to a document object model (DOM). Accordingly, the application server 106 may be further configured to generate sketch notes-based visual summary, which may be rendered on the user interface of the user-computing device 102, in accordance with the DOM, over the communication network 108.

In an embodiment, the application server 106 may be further configured to update the generated sketch notes-based visual summary based on the one or more input parameters provided by the user. The update of the generated sketch notes-based visual summary has been explained later in detail in conjunction with FIGS. 3A and 3B.

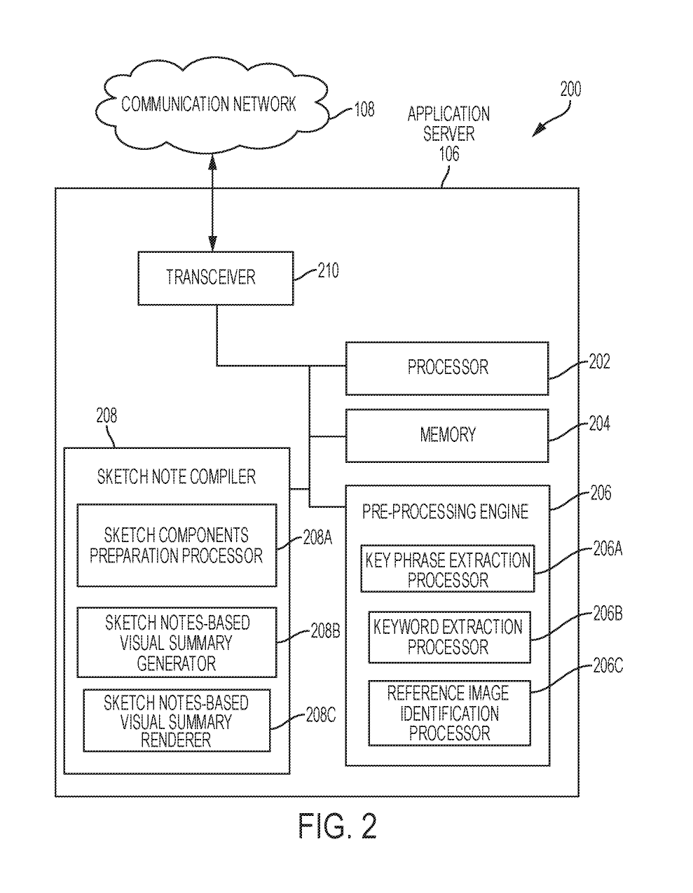

The application server 106 may be realized through various types of application servers, such as, but not limited to, a Java application server, a .NET framework application server, a Base4 application server, a PHP framework application server, or any other application server framework. An embodiment of the structure of the application server 106 is described later in FIG. 2.

A person having ordinary skill in the art will appreciate that the scope of the disclosure is not limited to realizing the content server 104 and application server 106 as separate entities. In an embodiment, the content server 104 may be realized as an application program installed on and/or running on the application server 106, without departing from the scope of the disclosure. Similarly, in an embodiment, the user-computing device 102 may be realized as an application program installed on and/or running on the application server 106, without departing from the scope of the disclosure.

The communication network 108 may include a medium through which one or more devices, such as the user-computing device 102, the content server 104, and the application server 106, may communicate with each other. Examples of the communication network 108 may include, but are not limited to, the Internet, a cloud network, a Wireless Fidelity (Wi-Fi) network, a wireless local area network (WLAN), a local area network (LAN), a wireless personal area network (WPAN), a WLAN, a wireless wide area network (WWAN), a cloud network, a long-term evolution (LTE) network, a plain old telephone service (POTS), and/or a metropolitan area network (MAN). Various devices in the system environment 100 may be configured to connect to the communication network 108, in accordance with various wired and wireless communication protocols. Examples of such wired and wireless communication protocols may include, but are not limited to, transmission control protocol and internet protocol (TCP/IP), user datagram protocol (UDP), hypertext transfer protocol (HTTP), file transfer protocol (FTP), ZigBee, EDGE, infrared (IR), IEEE 802.11, 802.16, cellular communication protocols, such as long-term evolution (LTE), light fidelity (Li-Fi), and/or other cellular communication protocols or Bluetooth (BT) communication protocols.

FIG. 2 is a block diagram that illustrates a system for auto-generation of a sketch notes-based visual summary of multimedia content, in accordance with at least one embodiment. With reference to FIG. 2, a system 200 is shown that may include a processor 202, a memory 204, a pre-processing engine 206, a sketch note compiler 208, and a transceiver 210. The pre-processing engine 206 may further include a key phrase extraction processor 206A, a keyword extraction processor 206B, and a reference image identification processor 206C. The sketch note compiler 208 may further include a sketch components preparation processor 208A, a sketch notes-based visual summary generator 208B, and a sketch notes-based visual summary renderer 208C.

The system 200 may correspond to a computing device, such as the user-computing device 102 or the application server 106, without departing from the scope of the disclosure. However, for the purpose of the ongoing description, the system 200 corresponds to the application server 106.

The processor 202 comprises a suitable logic, circuitry, interfaces, and/or code that may be configured to execute the one or more sets of instructions, programs, or algorithms stored in the memory 204 to perform the one or more operations. For example, the processor 202 may be configured to receive a request from the user-computing device 102 over the communication network 108 to generate the sketch notes-based visual summary of the multimedia content. In an embodiment, the processor 202 may be configured to communicate with a remote server, to retrieve the multimedia content based on a URL in the received request. Further, in an alternate embodiment, the processor 202 may retrieve sketch cell titles, sketch cell keywords, and a set of reference images from the user-computing device 102 at run time. In an embodiment, the processor 202 may be communicatively coupled to the memory 204, the pre-processing engine 206, the sketch note compiler 208, and the transceiver 210. The processor 202 may be further communicatively coupled to the communication network 108. The processor 202 may be implemented based on a number of processor technologies known in the art. The processor 202 may work in coordination with the memory 204, the pre-processing engine 206, the sketch note compiler 208, and the transceiver 210 for auto-generation of the sketch notes-based visual summary of the multimedia content. Examples of the processor 202 include, but are not limited to, an X86-based processor, a reduced instruction set computing (RISC) processor, an application-specific integrated circuit (ASIC) processor, a complex instruction set computing (CISC) processor, and/or other processors.

The memory 204 may be operable to store one or more machine code and/or computer programs that have at least one code section executable by the processor 202, the pre-processing engine 206, the sketch note compiler 208, and the transceiver 210. The memory 204 may store the one or more sets of instructions, programs, code, or algorithms that are executed by the processor 202, the pre-processing engine 206, the sketch note compiler 208, and the transceiver 210. In an embodiment, the memory 204 may include one or more buffers (not shown). In an embodiment, the one or more buffers may be configured to store the multimedia content corresponding to the received URL, the generated audio transcript, the extracted one or more key phrases, the identified one or more keywords, the retrieved set of reference images, the generated sketch images, and the generated sketch notes-based visual summary. Some of the commonly known memory implementations may include, but are not limited to, a random access memory (RAM), a read only memory (ROM), a hard disk drive (HDD), and a secure digital (SD) card. It will be apparent to a person having ordinary skill in the art that the one or more instructions stored in the memory 204 enables the hardware of the system 200 to perform the one or more operations.

The pre-processing engine 206 comprises a suitable logic, circuitry, interfaces, and/or code that may be configured to execute the one or more sets of instructions, programs, or algorithms stored in the memory 204 to perform the one or more operations. Examples of the one or more operations may include segmentation, key phrase extraction, keyword extraction, and reference image identification. The pre-processing engine 206 may include the key phrase extraction processor 206A, the keyword extraction processor 206B, and the reference image identification processor 206C. The pre-processing engine 206 may be implemented based on a number of processor technologies known in the art.

The key phrase extraction processor 206A in the pre-processing engine 206 may determine the one or more transitions in the video and/or audio stream, based on the key video events and/or the audio transcript, respectively, of the multimedia content. Based on the determined one or more transitions, the key phrase extraction processor 206A may determine one or more segments of the multimedia content. The key phrase extraction processor 206A may further determine one or more key phrases in the determined one or more segments of the multimedia content. Further, the key phrase extraction processor 206A may identify sketch cell titles based on the identified one or more key phrases in the determined one or more segments of the multimedia content.

The keyword extraction processor 206B in the pre-processing engine 206 may identify one or more keywords from the one or more key phrases. In an embodiment, the keyword extraction processor 206B, in conjunction with a natural language processor (not shown), may identify a pre-specified number of top keywords from the one or more identified keywords based on the frequency of occurrence of the one or more keywords in the extracted one or more key phrases. Further, the keyword extraction processor 206B, in conjunction with the natural language processor, may be configured to normalize the extracted one or more keywords eliminate at least one or more stop words from the extracted one or more key phrases. Further, the keyword extraction processor 206B may identify sketch cell keywords based on the normalized one or more keywords in the determined one or more segments of the multimedia content.

The reference image identification processor 206C in the pre-processing engine 206 may generate the set of sketch images (or sketch elements) of identified top reference images. Further, the reference image identification processor 206C may identify sketch cell images based on the set of sketch images in the determined one or more segments of the multimedia content.

The sketch note compiler 208 comprises a suitable logic, circuitry, interfaces, and/or code that may be configured to execute the one or more sets of instructions, programs, or algorithms stored in the memory 204 to perform the one or more operations. In an embodiment, the sketch note compiler 208 may retrieve sketch images from the memory 204 at run time and assign the retrieved sketch images to specific sketch representations as sketch cells. In an embodiment, the sketch note compiler 208 may be configured to recommend one or more sketch images based on a rough sketch of the images provided or drawn by the user. The sketch note compiler 208 may prepare sketch components. Thereafter, the sketch note compiler 208 may generate a sketch notes-based visual summary of the multimedia content. The sketch note compiler 208 may further render the generated sketch notes-based visual summary of the multimedia content on a user interface of the user-computing device 102. The sketch note compiler 208 may be communicatively coupled to the processor 202, the memory 204, the pre-processing engine 206, and the transceiver 210. The sketch note compiler 208 may be implemented based on a number of processor technologies known in the art.

The sketch components preparation processor 208A in the sketch note compiler 208 generates (or extracts) color palettes for the set of sketch images and assigns a specific template, sketch cell keywords, and sketch cell images to sketch cells for the one or more segments, to provide a logical structure to a sketch notes-based visual summary. The sketch components preparation processor 208A in the sketch note compiler 208 assigns the generated (or extracted) color palette, the templates, and the sketch cell keywords and sketch cell images, to the sketch cells. The sketch components preparation processor 208A may be further configured to compute sketch cell anchor points and overlay the sketch cell anchor points on the sketch templates in a pre-specified format such as an SVG format. In an embodiment, the sketch components preparation processor 208A may be configured to calculate the coordinates for each sketch cell by dividing the length of a sketch template by the number of sketch cells, such that the sketch cells are equidistant and have a threshold breathing space between them.

The sketch notes-based visual summary generator 208B in the sketch note compiler 208 first assigns the generated (or extracts) color palettes, templates, sketch cell keywords, and sketch cell images to corresponding sketch cells, in accordance with a pre-defined DOM with the key entities of a sketch cell image, a sketch cell title phrase, and sketch cell keywords. Accordingly, the sketch notes-based visual summary generator 208B generates a sketch notes-based visual summary of the multimedia content.

The sketch notes-based visual summary renderer 208C in the sketch note compiler 208 may render the generated sketch notes-based visual summary at the user interface of the user-computing device 102, in accordance with the sketch note object model. In an embodiment, the sketch notes-based visual summary renderer 208C may scale the sketch templates to fit a sketch viewing area in a user interface of the user-computing device 102 during rendering. In an embodiment, the sketch notes-based visual summary renderer 208C, in conjunction with the sketch notes-based visual summary generator 208B, may update the generated sketch notes-based visual summary of the multimedia content based on the one or more input parameters provided by the user at the user-computing device 102.

The transceiver 210 comprises a suitable logic, circuitry, interfaces, and/or code that may be configured to receive/transmit the one or more queries, request, multimedia content, input parameters, or other information from/to one or more computing devices or servers (e.g., the user-computing device 102, the content server 104, or the application server 106) over the communication network 108. The transceiver 210 may implement one or more known technologies to support wired or wireless communication with the communication network 108. In an embodiment, the transceiver 210 may be configured to retrieve the multimedia content from the content server 104. In an embodiment, the transceiver 210 may include circuitry, such as, but not limited to, an antenna, a radio frequency (RF) transceiver, one or more amplifiers, a tuner, one or more oscillators, a digital signal processor, a universal serial bus (USB) device, a coder-decoder (CODEC) chipset, a subscriber identity module (SIM) card, and/or a local buffer. The transceiver 210 may communicate via wireless communication with networks (such as the Internet), an Intranet and/or a wireless network (such as a cellular telephone network), a WLAN, and/or a metropolitan area network (MAN). The wireless communication may use any of a plurality of communication standards, protocols, and technologies, such as global system for mobile communications (GSM), enhanced data GSM environment (EDGE), wideband code division multiple access (W-CDMA), code division multiple access (CDMA), time division multiple access (TDMA), Bluetooth, light fidelity (Li-Fi), Wi-Fi (e.g., IEEE 802.11a, IEEE 802.11b, IEEE 802.11g, and/or IEEE 802.11n), voice over Internet Protocol (VoIP), Wi-MAX, a protocol for email, instant messaging, and/or short message service (SMS).

FIGS. 3A and 3B collectively depict a flowchart that illustrates a method for auto-generation of a sketch notes-based visual summary of multimedia content, in accordance with at least one embodiment. With reference to FIGS. 3A and 3B, a flowchart 300 is shown that is described in conjunction with FIG. 1 and FIG. 2. The method starts at step 302 and proceeds to step 304.

At step 304, the request is received from the user-computing device 102 to generate the sketch notes-based visual summary of the multimedia content. In an embodiment, the processor 202 may be configured to receive the request from the user-computing device 102 through the transceiver 210 over the communication network 108 to generate the sketch notes-based visual summary of the multimedia content.

In an embodiment, the request may include a uniform resource locator (URL) of the multimedia content for which the sketch notes-based visual summary is to be generated by the sketch note compiler 208. The URL may be provided by a user associated with the user-computing device 102.

In an alternate embodiment, the request may not include the URL of the multimedia content for which the sketch notes-based visual summary is to be generated by the sketch note compiler 208. In such a case, the request may directly correspond to the generation of the sketch notes-based visual summary for the multimedia content, and sketch cell titles, sketch cell keywords, and a set of reference images, in accordance to the method steps 310-330, as discussed hereinafter, are already executed by a pre-processing engine of the user-computing device 102 or a third-party server.

At step 306, a check is performed to determine whether the received request comprises only URL. In an embodiment, the processor 202 may be configured to perform the check to determine whether the received request comprises only the URL. In an embodiment, if the processor 202 determines that the received request does not comprise the URL, the control passes to step 308. Else, the control passes to step 310.

At step 308, when it is determined that the received request does not comprise the URL, the sketch cell titles, the sketch cell keywords, and the set of reference images may be retrieved from the user-computing device 102. In an embodiment, when the processor 202 determines that the received request does not comprise the URL, the processor 202 may be further configured to retrieve the sketch cell titles, the sketch cell keywords, and the set of reference images from the user-computing device 102, over the communication network 108. In such a case, a pre-processing engine (not shown) at the user-computing device 102 may be configured to pre-process the multimedia content to generate the sketch cell titles, the sketch cell keywords, and the set of reference images, and store the same at the user-computing device 102. Such pre-processing of the multimedia may be performed by the user-computing device 102 similar to the pre-processing of the multimedia performed by the application server 106, described in steps 310-338 of the flowchart 300 hereinafter. Once the processor 202 retrieves the sketch cell titles, the sketch cell keywords, and the set of reference images from the user-computing device 102, the control passes to step 332.

At step 310, when it is determined that the received request comprises the URL, the multimedia content corresponding to the URL is retrieved. In an embodiment, when the processor 202 determines that the received request comprises the URL, the processor 202 may be configured to retrieve the multimedia content, corresponding to the URL in the received request, from the content server 104. Such retrieval of the multimedia content may be performed through the transceiver 210 over the communication network 108. In an embodiment, the multimedia content corresponding to the URL may be pre-stored at a database server. In yet another embodiment, the multimedia content corresponding to the URL may be streamed from a content source in real time.

At step 312, a check is performed to determine whether the retrieved multimedia content includes an audio transcript. In an embodiment, the pre-processing engine 206 may be configured to perform the check to determine whether the retrieved multimedia content comprises an audio transcript. In an embodiment, if the pre-processing engine 206 determines that the retrieved multimedia content does not comprise an audio transcript, then the control passes to step 314. Else, the control passes to step 318.

At step 314, when it is determined that the retrieved multimedia content does not comprise audio transcript, a further check is performed to determine whether specific library routines or ASR algorithm for extracting audio transcripts are available in the memory 204. In an embodiment, the pre-processing engine 206 may be configured to perform the check to determine whether the specific library routines or ASR algorithm for extracting the audio transcripts are available in the memory 204. In an embodiment, if the pre-processing engine 206 determines that the specific library routines or ASR algorithm for extracting audio transcripts are not available in the memory 204, then the control passes to step 320. Else, the control passes to step 316.

At step 316, when it is determined that the specific library routines or ASR algorithm for extracting the audio transcripts are available in the memory 204, the pre-processing engine 206 may be configured to execute such specific library routines or the ASR algorithm (pre-stored in the memory 204). Based on the execution of the ASR algorithms, the pre-processing engine 206 may determine timestamps mapped to each word in the text. In an embodiment, a speech-to-text generating processor in the pre-processing engine 206 may determine the audio transcripts from the audio stream of the multimedia content by utilizing one or more speech processing techniques known in the art. Examples of the one or more speech processing techniques may include, but are not limited to, pitch tracking, harmonic frequency tracking, speech activity detection, and a spectrogram computation. The control passes to step 318.

At step 318, when it is determined that the retrieved multimedia content comprises the audio transcript and the specific library routines or the ASR algorithms are executed to determine timestamps mapped to each word in the text, beginning and ending timestamps of each paragraph in the audio transcript are identified. In an embodiment, when the pre-processing engine 206 determines that the retrieved multimedia content comprises audio transcript and the specific library routines or the ASR algorithms are executed, the pre-processing engine 206 may be further configured to identify beginning and ending timestamps of each paragraph in the audio transcript. The control passes to step 320.

At step 320, one or more transitions in the audio and/or video stream of the multimedia content may be determined. In an embodiment, the pre-processing engine 206 may be configured to determine one or more transitions in the audio and/or video stream of the multimedia content. In an embodiment, when it is determined that the retrieved multimedia content comprises audio transcript, the key phrase extraction processor 206A in the pre-processing engine 206 may be configured to determine one or more transitions in the audio stream of the multimedia content based on beginning and ending timestamps of each paragraph in the audio transcript. In an embodiment, when it is determined that the specific library routines and ASR algorithms are executed to determine timestamps mapped to each word in the text, the key phrase extraction processor 206A in the pre-processing engine 206 may be configured to determine one or more transitions in the audio stream of the multimedia content based on timestamps corresponding to a change in paragraph or a change in the topic in the audio transcript.

In an embodiment, the key phrase extraction processor 206A in the pre-processing engine 206 may be configured to determine the one or more transitions in the audio transcript based on one or more aesthetic features associated with the one or more phrases in the audio transcript of the multimedia content. In an embodiment, the one or more aesthetic features may correspond to one or more of, but are not limited to, underline, highlight, bold, italics, font size, and the like. In an exemplary scenario, the aesthetic features may be introduced in the audio transcript when a presenter in the multimedia content may have written a phrase on a white board to mark the beginning of a new topic.

In another embodiment, the key phrase extraction processor 206A in the pre-processing engine 206 may be configured to determine the one or more transitions in the audio transcript based on one or more acoustic features associated with the one or more phrases in the audio transcript of the multimedia content. In an embodiment, the one or more acoustic features may correspond to one or more of, but are not limited to, pitch contour, intensity contour, frequency contour, speech rate, rhythm, and duration of the phonemes in the speech of the presenter. In an exemplary scenario, the acoustic features may be introduced in the audio transcript when the speech of the presenter in the multimedia content may have a pitch contour, an intensity contour, a frequency contour, varying speech rates, varying speech rhythms, and a significant duration of the phonemes and syllables.

In an embodiment, when it is determined that the timestamps in the audio transcript are not available, visual cues, such as timestamps corresponding to slide transition (wherein point of discussion changes from one context to another), may be determined. In an embodiment, when the pre-processing engine 206 determines that the timestamps in the audio transcript are not available, the key phrase extraction processor 206A in the pre-processing engine 206 may be configured to determine the one or more transitions based on timestamps corresponding to slide transitions, wherein point of discussion changes from one context to another. In such an embodiment, each transition from the one or more transitions in the multimedia content may be determined based on switching from one or more first events associated with one or more first frames in the multimedia content to one or more second events associated with one or more second frames in the multimedia content. In other words, slide transitions may correspond to points in the video stream at which the points of discussions change from one context to another.

A person having ordinary skill in the art will understand that the above-mentioned exemplary scenario is for illustrative purpose and should not be construed to limit the scope of the disclosure. In an embodiment, the set of acoustic features may further include other audio features, such as lexical stress, associated with the audio content in the multimedia content.

At step 322, the one or more segments of the multimedia content are determined based on the determined one or more transitions. In an embodiment, a segmentation module in the key phrase extraction processor 206A may be configured to determine the one or more segments of the multimedia content based on the determined one or more transitions. For example, in the multimedia content, an instructor may discuss an introduction of a topic, followed by three sub-topics and the conclusion. In such a case, the first transition may occur when the introduction switches to the first sub-topic, the second transition may occur when the first sub-topic switches to the second sub-topic, the third transition may occur when the second sub-topic switches to the third sub-topic, and the fourth transition may occur when the third sub-topic switches to the conclusion. In such a case, the segmentation processor in the pre-processing engine 206 may determine five segments in the multimedia content.

In an embodiment, the segmentation module in the key phrase extraction processor 206A may utilize the one or more segmentation techniques, known in the art. Examples of the one or more segmentation techniques may include, but are not limited to, normalized cut segmentation technique, graph cut segmentation technique, and minimum cut segmentation technique. In an embodiment, each of the identified one or more segments may be associated with a topic among the one or more topics described in the multimedia content. A person having ordinary skill in the art will understand that the above-mentioned example is for illustrative purpose and should not be construed to limit the scope of the disclosure.

At step 324, the one or more key phrases are extracted from the generated one or more segments. In an embodiment, the key phrase extraction processor 206A in the pre-processing engine 206 may be configured to extract the one or more key phrases from the generated one or more segments.

In an embodiment, the key phrase extraction processor 206A in the pre-processing engine 206 may be configured to extract the one or more key phrases from the generated one or more segments using one or more library routines such as ffmpeg library. In an embodiment, the user may perform an input operation on the one or more key phrases to navigate to the corresponding time instant (partition point) in the multimedia content. In an embodiment, in response to the input operation on the one or more key phrases, the user-computing device 102 may be configured to display one or more frames, related to the one or more key phrases, from the multimedia content. In an embodiment, one or more APIs may be configured to identify salient or key phrases in the determined segments. In accordance with an embodiment, based on the one or more extracted key phrases, a title of each sketch cell may be determined for the sketch notes-based visual summary that is to be generated by the application server 106.

At step 326, the one or more keywords are identified from the one or more key phrases. In an embodiment, the keyword extraction processor 206B in the pre-processing engine 206 may be configured to identify the one or more keywords from the one or more key phrases. The keyword extraction processor 206B may be configured to determine label classification for identifying abstract representation presented in the corresponding segment. The keyword extraction processor 206B may be further configured to determine relationship between the current segment and the next segment and accordingly, assigns a label to the two segments.

In an embodiment, the keyword extraction processor 206B, in conjunction with the natural language processor, may normalize the extracted one or more keywords in the generated transcript to eliminate at least one or more stop words from the extracted one or more keywords. Various examples of the stop words may correspond to articles, prepositions, conjunctions, interjections, and/or the like, such as “in,” “and,” “of,” and “is.” The keyword extraction processor 206B, in conjunction with the natural language processor, may normalize the extracted one or more keywords by use one or more text processing techniques such as stemming.

In another exemplary embodiment, the key phrase extraction processor 206A may extract two key phrases, such as “New Delhi is the capital of India” and “The president's house is in New Delhi” from a segment in the generated audio transcript. In such a case, the keyword extraction processor 206B, in conjunction with the natural language processor, may identify the two keywords, such as, “New Delhi” and “The President's house” from the two key phrases. The keyword extraction processor 206B, in conjunction with the natural language processor, may further eliminate one or more stop words, such as “is,” “the,” “of,” “in,” and “at,” from the extracted one or more key phrases to normalize the extracted one or more keywords.

In another exemplary embodiment, the keyword extraction processor 206B, in conjunction with the natural language processor, may identify a plurality of keywords, such as “playing,” “player,” “plays,” and “played,” with the same root word, such as “play,” using a character recognition technique. The keyword extraction processor 206B, in conjunction with the natural language processor, may perform the stemming of the plurality of keywords to reduce the identified keywords to the root word, i.e., “play.”

In an embodiment, the keyword extraction processor 206B, in conjunction with the natural language processor, may identify a pre-specified number of top keywords from the one or more identified keywords based on the frequency of occurrence of the one or more keywords in the extracted one or more key phrases. In accordance with an embodiment, based on the identified one or more keywords, sketch cell keywords may be determined for the sketch notes-based visual summary that is to be generated by the application server 106.

At step 328, the set of reference images is retrieved from the reference image repository based on each of the identified one or more keywords. In an embodiment, the reference image identification processor 206C in the pre-processing engine 206, in conjunction with the custom search and/or the one or more APIs, may be configured to retrieve the set of reference images from the reference image repository based on each of the identified one or more keywords in each of the determined one or more segments. The retrieval of the set of reference images may be based on each of the identified one or more keywords to avoid redundancy and irrelevancy of reference image search results. In an embodiment, each reference image from the retrieved set of reference images may be tagged with a keyword from the one or more keywords. However, to avoid all the video segments that have a similar set of reference images across varied keywords, one or more known in the art open-source image database, such as NounProject, may be utilized to tag the set of reference images. By utilizing A tag-based search on such one or more known in the art library routines, a pre-specified number of top reference images for every video segment may be identified that effectively represents the context of the segment.

In accordance with the exemplary scenario described above, the reference image identification processor 206C in the pre-processing engine 206 may retrieve the set of reference images, tagged with the identified each of the one or more keywords, such as “New Delhi” and “The president's house,” from the web and may further store the retrieved reference images in the memory 204.

At step 330, the set of sketch images (or sketch elements) of identified top reference images is generated. In an embodiment, the reference image identification processor 206C in the pre-processing engine 206 may be configured to generate the sketch image of each of the identified pre-specified number of top reference images.

After the retrieval of the pre-specified number of top reference images, the reference image identification processor 206C may perform a first layer processing to threshold the pre-specified number of top reference images and provide two sets of colors, i.e., a major color and a minor color, to the pre-specified number of top reference images. A pattern may be overlaid on the major color of the pre-specified number of top reference images. Thereafter, the reference image identification processor 206C may perform the second layer processing to obtain image edges by utilizing one or more edge detection techniques, such as the Sobel edge detection technique. Thereafter, the reference image identification processor 206C may overlay the obtained image edges over the layer generated through the first layer processing to generate the finalized sketch images. In an embodiment, such image processing may be performed by one or more dynamic scripts, such as ProceessingJS, being executed on a third-party web server. In such a case, the third-party web server may store the set of sketch images in a specific format, such as SVG format, at the client side, such as the user-computing device 102, which may be later retrieved at run time by the application server 106. In accordance with an embodiment, based on the generated sketch images, sketch cell images may be determined for the sketch notes-based visual summary that is to be generated by the application server 106.

At step 332, a color palette is extracted for the set of sketch images. In an embodiment, the sketch components preparation processor 208A in the sketch note compiler 208 may use one or more APIs from an open-source platform, such as Colr.org®, to extract a color scheme for the sketch notes-based visual summary. The one or more APIs may provide the color palette in the form of hexcodes, based on the tag searched. For example, a tagged search for a keyword “Sky” may return a hexcode “#8abceb.” The darker color, thus obtained, may be assigned to texts and edges, while the lighter color may be used as a fill color of the set of sketch images.

At step 334, words and sketch images are assigned for sketch cells for each segment. In an embodiment, the sketch components preparation process or 208A in the sketch note compiler 208 may retrieve sketch images from the memory 204 at run time and assign the retrieved sketch images for specific sketch representations as sketch cells. The sketch components preparation processor 208A in the sketch note compiler 208 may further assign fonts to the sketch cell title and sketch cell keywords, determined by the pre-processing engine 206 described above. The number of sketch cells corresponds to the number of segments. In such an embodiment, the pre-processing engine 206 is one of the various components of the application server 106. In another embodiment, the sketch components preparation processor 208A in the sketch note compiler 208 may retrieve sketch images from the local memory of the user-computing device 102 at run time and assign the retrieved sketch images to a specific sketch representation as sketch cells. In such an embodiment, the pre-processing engine 206 is one of the various components of the user-computing device 102 or the content server 104.

At step 336, the sketch cells may be assigned to pre-defined layouts, such as sketch templates. In an embodiment, the sketch components preparation processor 208A in the sketch note compiler 208 may be configured to assign the sketch cells to sketch templates to provide a logical structure to sketch notes-based visual summary. Such logical structures may contain one or more sketch cells. The sketch components preparation processor 208A in the sketch note compiler 208 may be further configured to compute sketch cell anchor points and overlay the sketch cell anchor points on the sketch templates in a pre-specified format, such as SVG format. The sketch template may be one of a fluidic layout, an organic layout, or a linear layout. The sketch cells being the key objects in the sketch object model may follow various types of dynamically assigned sketch templates. In an embodiment, the sketch components preparation processor 208A in the sketch note compiler 208 may be configured to scale the sketch templates to fit a sketch viewing area in a user interface of the user-computing device 102 during rendering. For instance, the length of the multimedia content is long. In such a case, the length of the sketch template may be dynamically increased based on the number of sketch cells. In an embodiment, the sketch components preparation processor 208A in the sketch note compiler 208 may be configured to calculate the coordinates for each sketch cell by dividing the length of a sketch template by the number of sketch cells, such that the sketch cells are equidistant and have a threshold breathing space between them.

In certain embodiments, the sketch components preparation processor 208A in the sketch note compiler 208 may be further configured to identify the most appropriate sketch template based on various factors, such as multimedia content properties (e.g., the context of the topic), speaker movements, and emotional classification of visual cues or audio transcript.

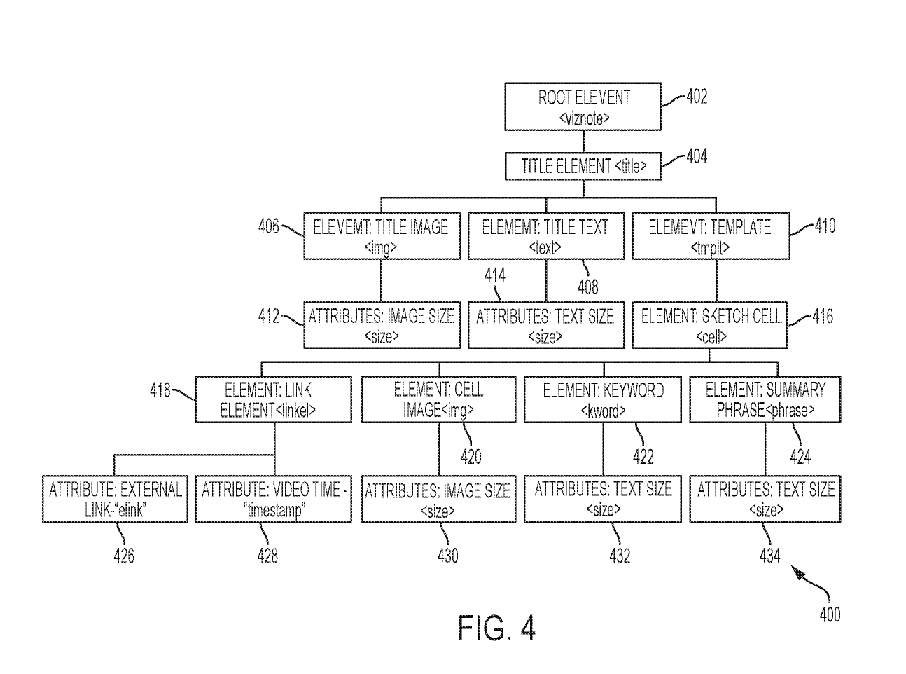

At step 338, the sketch components, such as color palette and sketch templates as described above, are assigned to a pre-defined document object model (DOM. In an embodiment, the sketch components preparation processor 208A may assign the sketch components to a pre-defined DOM, such as sketch object model 400 described in FIG. 4. The pre-defined DOM encompasses the structure of the sketch notes-based visual summary and the relational and chronological attributes of the sketch cells that correspond to sketch objects. Different multimedia content segment relationships may be presented in the sketch notes-based visual summary by manifesting the sketch object attributes. The pre-defined DOM may allow easier document manipulation when a user interacts with the sketch notes-based visual summary.

Key features of the sketch template that may be achieved by implementing the sketch object model have been described above. The first key feature may be that the adjacency of the sketch cells along the sketch template presents the chronological relationship among the segments of the multimedia content. The second key feature may be that if two sketch cells, such as (SCᵢ) and (SCᵢ₊ₙ), are related or present the same context, such two sketch cells may be shown along with a connector object in the sketch template. The third key feature may be that if two sketch cells, such as (SCᵢ) and (SCᵢ₊ₙ), are related, such two sketch cells may be shown with a similar color scheme or highlighting style. The fourth key feature may be that different sketch object attributes and sketch elements may be accessed in run time and may be modified by “id” based referencing. For example, if a sketch cell has an id “cellOne,” sub-elements, such as image (i.e., “img”) and its attributes (such as “size”), may be changed by referring to the id “cellOne” (e.g., cellOne.img=“xyz.jpg” or cellOne.img.size=“120,120”). The fifth key feature may be that each major sketch element may be customized according to corresponding automatic changes in sub-elements. For example, if a sketch template is changed from “fluidic” to “organic,” the sketch cells' positions are also changed. Such positioning of sketch cells is responsive to and changed according to the screen resolution of the user interface of the user-computing device 102. This is achieved by not allowing any overlay of sketch cells with one another.

At step 340, the sketch notes-based visual summary of the multimedia content is generated. In an embodiment, the sketch notes-based visual summary generator 208B in the sketch note compiler 208 may be configured to generate the sketch notes-based summary of the multimedia content once the sketch cells are assigned to a pre-defined layout, i.e., a sketch template, in conjunction with the pre-defined DOM. The sketch notes-based visual summary may comprise at least one or more of, but not limited to, one or more sketch elements, one or more connectors, and one or more keywords.

At step 342, the generated sketch notes-based visual summary is rendered on the user interface of the user-computing device 102, in accordance with the pre-defined DOM, such as the object model 400 described in details in FIG. 4. In an embodiment, the sketch notes-based visual summary renderer 208C in the sketch note compiler 208 may be configured to render the sketch cells based on the pre-defined object model with the key entities of a sketch cell image, a sketch cell title phrase, and sketch cell keywords. In such a case, the sketch cells correspond to sketch objects, based on which the sketch notes-based visual summary is rendered at the user-computing device 102.

In an embodiment, the sketch notes-based visual summary renderer 208C in the sketch note compiler 208 may be configured to render the generated sketch notes-based visual summary on the user interface of the user-computing device 102, over the communication network 108. In an embodiment, the user interface of the user-computing device 102 may be partitioned into a plurality of display portions. Further, the plurality of display portions may correspond to the identified one or more keywords, the transcript of each of the determined one or more segments, one or more sketch elements, and the generated sketch notes-based visual summary, as described in detail in FIG. 6.

At step 344, the generated sketch notes-based visual summary of the multimedia content is updated based on the one or more input parameters provided by the user. In an embodiment, the sketch notes-based visual summary generator 208B in the sketch note compiler 208 may be configured to update the generated sketch notes-based visual summary of the multimedia content based on the one or more input parameters provided by the user at the user-computing device 102. The one or more input parameters may correspond to manipulation (i.e., addition, replacement, or deletions) of one or more sketch elements and/or keywords, freehand overlay drawing, navigation through the multimedia content, accessing visual vocabulary, and the like. The sketch notes-based visual summary renderer 208C in the sketch note compiler 208 may be configured to render the updated sketch notes-based visual summary on the user interface of the user-computing device 102, over the communication network 108.

In an embodiment, the sketch note compiler 208 may be configured to recommend one or more sketch images based on a rough sketch of the images provided or drawn by the user. Such recommendation may be provided by one or more trained multi-class neural network-based classifiers. The control passes to end step 346.

FIG. 4 is a block diagram that illustrates a pre-defined object model, in accordance with at least one embodiment. With reference to FIG. 4, there is shown an exemplary sketch object model 400 that has been described in conjunction with FIG. 1, FIG. 2, and FIGS. 3A and 3B.

The sketch object model 400 may comprise a plurality of sketch elements and corresponding attributes arranged in a hierarchal logical structure that may be used to create the sketch cells. The sketch note compiler 208, using the sketch object model 400 and a scripting language, such as ProceessingJS, may subsequently render the sketch cells as the sketch notes-based visual summary of multimedia content on the user interface of the user-computing device in run time. The scripting language may be used to render the sketch notes-based visual summary of multimedia content, in accordance with the sketch object model 400 with the key entities of a sketch cell reference image, the sketch cell title, and the sketch cell keyword labels. The sketch object model 400 allows easy object manipulation as well as the customization and integration of the sketch elements through the sketch cells in the frontend user-interface programming languages at the user-computing device 102. The sketch object model 400 may encompass the structure of the sketch notes-based visual summary of multimedia content, and its relational and chronological attributes. Relationships among different segments may be presented in the different segments by manifesting the sketch object attributes.

With reference to the sketch object model 400 in FIG. 4, there are shown sketch elements and attributes corresponding to each sketch cell of the sketch notes-based visual summary of multimedia content. For example, a root node 402 corresponds to the root sketch element representing the sketch notes-based visual summary of multimedia content document. Node 404 corresponds to title sketch element representing the sketch cell title of the sketch notes-based visual summary of multimedia content. Nodes 406, 408, and 410 correspond to sketch elements, such as title image, title text, and template, respectively. Nodes 412, 414, and 416 are associated with the nodes 406, 408, and 410, respectively. The nodes 412 and 414 correspond to attributes of the corresponding sketch elements. For example, the node 412 corresponds to an attribute image size of the sketch element title image, represented by the node 406. Similarly, the node 414 corresponds to an attribute text size of the sketch element title text, represented by the node 408. The node 416 corresponds to a sub-sketch element, such as sketch cell, corresponding to the sketch element, such as template, represented by the node 410.

Nodes 418, 420, 422, and 424 correspond to sub-sketch elements, such as link element, cell image, keyword, and summary phrase, associated with the sketch element and sketch cell represented by the node 416. Nodes 426 and 428 correspond to attributes, such as external link and video timestamp, associated with the sketch element and link element represented by the node 418. Node 430 corresponds to attributes, such as image size, associated with the sketch element and cell image represented by the node 420. Node 432 corresponds to attribute, such as text size, associated with the sketch element, keyword, represented by the node 422. Node 434 corresponds to attributes, such as text size, associated with the sketch element and summary phrase represented by the node 424.

Different attributes and elements, represented by the nodes 402 to 434 may be accessed in run time and may be modified by “id” based referencing, as described in FIGS. 3A and 3B. Further, each major sketch element may be customized based on corresponding automatic changes in sub-elements. For example, if the sketch cell is changed from one pre-defined sketch template to other, such as from “fluidic” to “organic,” the sketch cell positions may also change. Other features of the sketch object model 400 have already been described in FIGS. 3A and 3B.

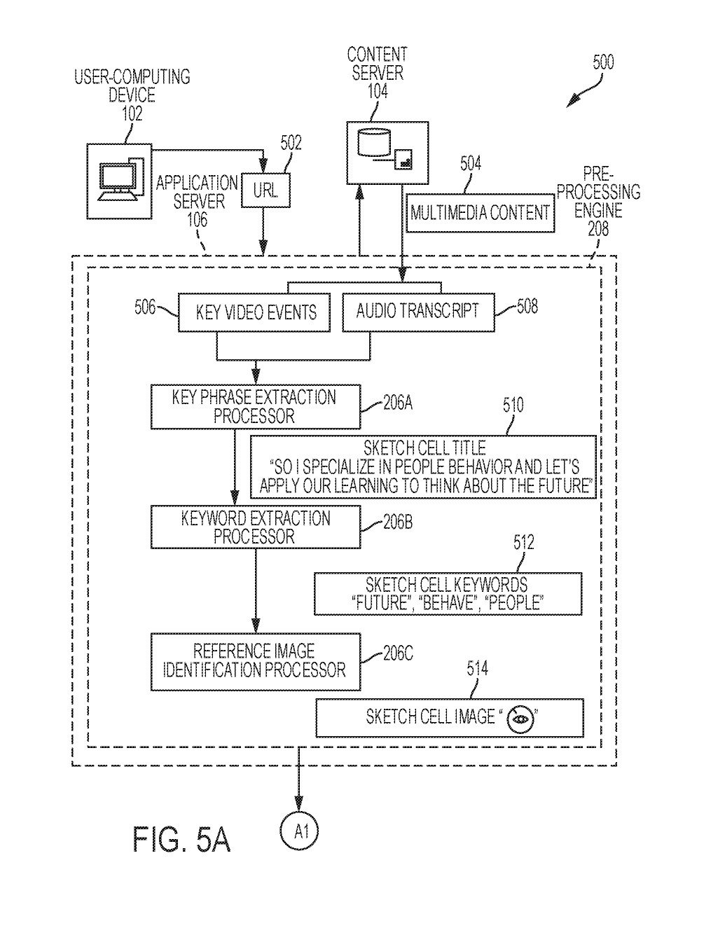

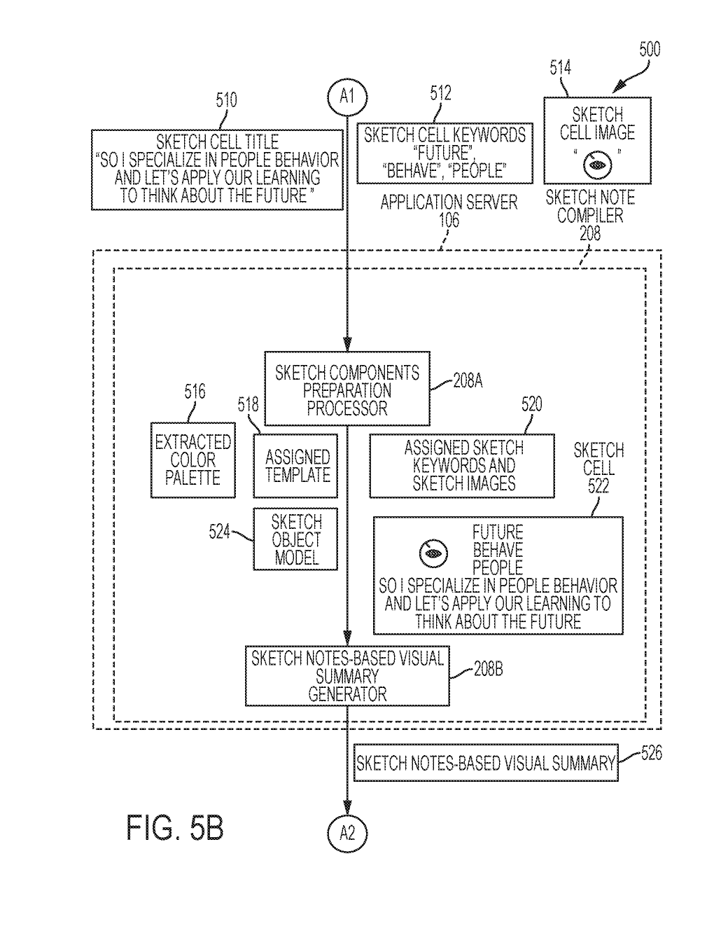

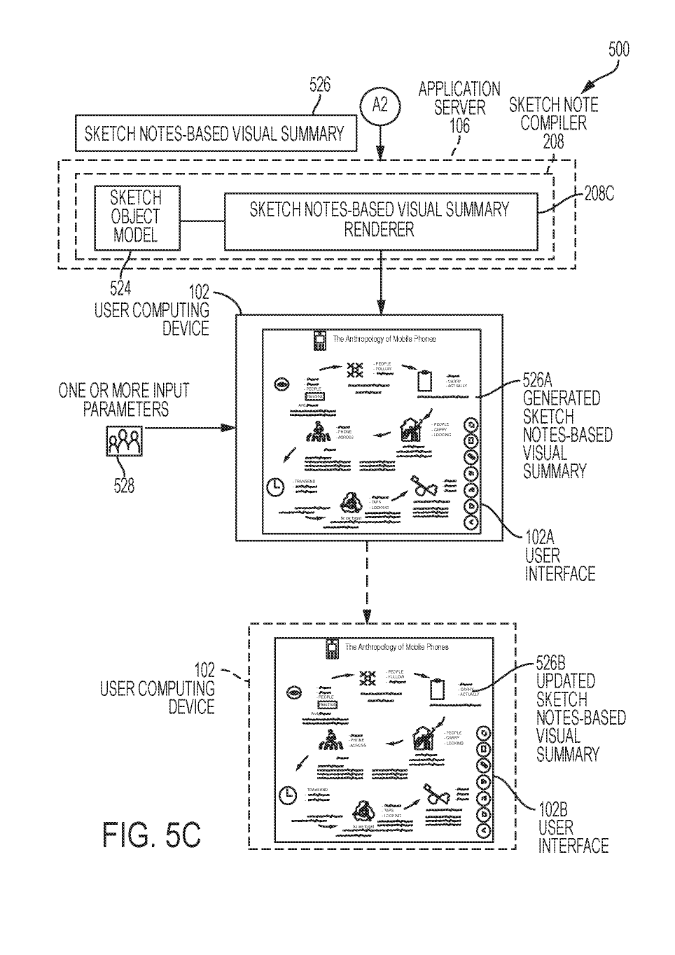

FIGS. 5A, 5B, and 5C collectively illustrate an exemplary workflow for auto-generation of sketch notes-based visual summary of multimedia content, in accordance with at least one embodiment. With reference to FIGS. 5A, 5B, and 5C, there is shown an exemplary workflow 500, described in conjunction with FIG. 1, FIG. 2, FIG. 3A, FIG. 3B, and FIG. 4. The exemplary workflow 500 includes a URL 502, multimedia content 504, key video events 506, audio transcript 508, a sketch cell title 510, sketch cell keywords 512, a sketch cell image 514, extracted color palette 516, assigned template 518, assigned sketch keywords and sketch images 520, a sketch cell 522, sketch object model 524, a sketch notes-based visual summary 526, a generated sketch notes-based visual summary 526A, an updated sketch notes-based visual summary 526B, and an input sketch image 528. There is further shown a user interface 102A that illustrates the generated sketch notes-based visual summary rendered by the application server 106. There is further shown another user interface, such as the user interface 102B, that illustrates the updated sketch notes-based visual summary rendered by the application server 106.

With reference to the exemplary workflow 500, the user-computing device 102 transmits a request to the application server 106. The request includes the URL 502 of the multimedia content 504 (stored in the content server 104) for which the sketch notes-based visual summary 526 is to be generated by the application server 106. The URL 502 may be provided by a user associated with the user-computing device 102. In such a case, the processor 202 may communicate with the content server 104, over the communication network 108, to retrieve the multimedia content 504 based on the URL 502 included in the received request. The multimedia content 504 may correspond to a topic, such as “The anthropology of mobile phones,” and includes the key video events 506 and the audio transcript 508.

The key phrase extraction processor 206A in the pre-processing engine 206 determines one or more transitions in the video and/or audio stream, based on the key video events 506 and/or the audio transcript 508, respectively. The key phrase extraction processor 206A further determines one or more segments of the multimedia content 504 based on the determined one or more transitions. From each of the one or more segments corresponding to the audio transcript 508, the key phrase extraction processor 206A extracts one or more key phrases that may indicate respective titles of the sketch cells. For example, a key phrase “So I specialize in people behavior and let's apply our learning to think about the future” from the introductory segment may indicate the sketch cell title 510 of an exemplary sketch cell that would be the first sketch cell of the sketch notes-based visual summary 526. Similarly, other key phrases may indicate sketch cell titles of other sketch cells.

Thereafter, the keyword extraction processor 206B in the pre-processing engine 206 identifies one or more keywords from the one or more key phrases that may be further assigned as keywords of the sketch cells. For example, keywords “Future,” “Behave,” and “People” may indicate the sketch cell keywords 512 of the exemplary sketch cell. Similarly, other keywords may indicate sketch cell keywords of other sketch cells.

Thereafter, the reference image identification processor 206C in the pre-processing engine 206 retrieves a set of reference images from a reference image repository based on each of the identified one or more keywords by utilizing tag-based search on such one or more known in the art library routines. Accordingly, a pre-specified number of top reference images for every video segment may be identified that represents the context of the segment. The reference image identification processor 206C further generates the set of sketch images (or sketch elements) of identified top reference images. For example, an exemplary sketch image, as shown in FIG. 5A, indicates the sketch cell image 514 of the exemplary sketch cell. Similarly, other sketch cell images may indicate other sketch cells.

The sketch cell titles (such as the sketch cell title 510), sketch cell keywords (such as the sketch cell keywords 512), and sketch cell images (such as the sketch cell image 514), corresponding to the one or more segments (such as an introductory segment) are communicated to the sketch note compiler 208.

The sketch components preparation processor 208A in the sketch note compiler 208 generates (or extracts) color palettes for the set of sketch images. The sketch components preparation processor 208A further assigns a specific template, such as a fluidic template, for generating the sketch notes-based visual summary 526 of the multimedia content 504. The sketch components preparation processor 208A further assigns sketch cell keywords and sketch cell images to sketch cells for the one or more segments. For example, the sketch components preparation processor 208A assigns the sketch cell keywords 512 and the sketch cell image 514 to the exemplary sketch cell, such as sketch cell 522, of the introductory segment, in accordance with the sketch object model 524. The sketch object model 524 encompasses the structure of the sketch notes-based visual summary 526 and its relational and chronological attributes.

The sketch notes-based visual summary generator 208B in the sketch note compiler 208 assigns the generated (or extracts) color palettes (such as the extracted color palette 516), templates (such as the assigned template 518), sketch cell keywords (such as the assigned sketch keywords and sketch images 520), and sketch cell images (such as the sketch cell image 514) to corresponding sketch cells (such as the sketch cell 522), in accordance with a pre-defined DOM (such as the sketch object model 524). Accordingly, the sketch notes-based visual summary generator 208B generates the sketch notes-based visual summary 526 of the multimedia content 504.

Thereafter, the sketch notes-based visual summary renderer 208C in the sketch note compiler 208 renders the generated sketch notes-based visual summary 526A at the user interface of the user-computing device 102, in accordance with the sketch object model 524. The generated sketch notes-based visual summary 526A is viewed by the user through the user interface 102A rendered by the sketch notes-based visual summary renderer 208C at the display screen of the user-computing device 102.

The user may provide one or more input parameters, such as an input sketch image 528, to replace the sketch image of the second sketch cell of the generated sketch notes-based visual summary 526A. Accordingly, the sketch notes-based visual summary generator 208B updates the generated sketch notes-based visual summary 526A of the multimedia content 504. The sketch notes-based visual summary renderer 208C in the sketch note compiler 208 renders the updated sketch notes-based visual summary 526B at the user interface 102B of the user-computing device 102, in accordance with the sketch object model 524. The updated sketch notes-based visual summary 526B is viewed by the user through the user interface 102B rendered by the sketch notes-based visual summary renderer 208C at the display screen of the user-computing device 102.

FIG. 6 illustrates an exemplary snapshot depicting a sketch notes-based visual summary of the multimedia content at the user interface of a user-computing device, in accordance with at least one embodiment. With reference to FIG. 6, there is shown an exemplary snapshot 600 that has been described in conjunction with FIGS. 1-5.

The snapshot 600 is displayed at the user interface of a user-computing device 102. The user interface is integrated by embedding the processing code within the screen of the user-computing device 102 along with the YouTube® iframe, and header elements, which may be coded using a markup language, such as HTML5.

The snapshot 600 includes three display sections 602, 604, and 606. Initially, the snapshot 600 includes a display section (not shown) that corresponds to a screen that prompts the user to provide a URL of multimedia content, such as a TED-talk video clip available on YouTube®, for example, based on which the application server 106 generates a sketch notes-based visual summary.

The first display section 602 corresponds to a multimedia content player that plays the multimedia content streamed by the content server 104. The URL of the multimedia content is provided by the user. In the first display section 602, the multimedia content player provides multiple controls through which the user may pause, play, and scrub the multimedia content at any time. Each sketch cell carries its respective video segment time stamp as a seeking point. The first display section 602 also serves for the capturing of a specific object, which may be a formula, diagram, or any other pre-defined element in the multimedia content using the screen capture control. The screen capture control may capture the image using the get (x, y, w, h) function, save in the local memory, and render on a user-defined position allowing a resizing function per user customization.

The second display section 604 corresponds to sketch control section that includes word collection, captured subtitles, and a sketch element component library. The pre-determined number of top keywords identified from each of the one or more segments is displayed as the word collection. The audio transcript may be displayed as the captured subtitles. Both keywords and sentence-wise audio transcripts may be dragged and dropped into the third display section 606. The sketch elements may be stored in the pre-determined files, such as SVG files, in the local storage. An iterator in the pre-program collects the number of SVG elements and the file names. The sketch elements may be displayed as small icons under second display section 604. For the design of sketch elements, one or more known in the art sketching tools, such as Microsoft Smart Art®, may be utilized that have a predefined classification of graphics such as lists, cycles, process, shapes, lines and the like.

The third display section 606 corresponds to a viewer or editor that displays the sketch notes-based visual summary rendered by the application server 106. The third display section 606 comprises a canvas onto which different layers, such as the generated sketch-notes-based visual summary, pencil layer, erase layer, sketch element layer, screen capture layer, and the like, may be rendered. The third display section 606 is designed to be responsive for the screen-size compatibility of the user-computing device 102.

The third display section 606 allows the user to drag and drop any sketch component or screen capture layer in the sketch notes-based visual summary, through various stylus- and mouse-based interaction capabilities. The user may perform a pre-specified operation, such as long click, on a specific sketch cell for editing. The user may further add a link to any of the sketch components for quick video navigation for a later point in time. On dragging and dropping some sketch elements, such as box, circle or a cloud, an optional text box may appear that may enable the user to enter text into the sketch element. A sketch-like font may be used for rendering the text. The user may change the set of sketch images displayed on the sketch cells clicking and holding to reveal an optional set of pre-determined number of, such as five, top image search results of the same keyword. Thus, the user is enabled to replace the set of sketch images based on preference. In an instance, the pre-determined number of top images may be obtained from the Noun Project library for specific sketch cells may be used by a basic back propagation algorithm, known in the art. In another instance, a multiclass neural network may be trained beforehand so that the set of sketch images may be used to predict the images to be drawn by the user. The user may have the option to draw basic outline strokes and press a button, in response to which the outline strokes may be processed in the neural network and similar images may be shown as options for the user to select from. Accordingly, the visual vocabulary of the user may be augmented, nudging them to draw richer visual notes.

The snapshot 600 may further include user controls that may be presented in clicking a floating action button (FAB) overlaid on third display section 606. In an instance, a multimedia content pausing feature by may be activated when the FAB is clicked. The user controls have anchors for screen capture, clear screen, link, undo, redo, save (to “Your Videos”) and share the sketch notes-based visual summary (as PDF, mail). The user controls were implemented using one or more GUI libraries, known in the art.

The disclosed embodiments encompass numerous advantages. The disclosure provides a method and a system for the auto-generation of a sketch notes-based visual summary of the multimedia content that uses sketches for summarizing the multimedia content. The sketch notes-based visual summary of the multimedia content may be utilized to extract video transcripts information along with key visual cues from video events, and may be presented as structured and organic visual summary snippets. The sketch object model facilitates the creation of sketch cells and rendering the sketch cells in run time. The sketch object model further allows the user easy object manipulation and customization and integration with frontend user-interface programming languages. The viewing/editing interfaces for the sketch notes-based visual summary of the multimedia content may provide the capability to include video elements inside the visual summary for sharing, referencing, and quick content navigation. The sketch notes-based visual summary of the multimedia content may serve as a quick refresher for the user and further compliment other multimedia interaction techniques.

The disclosed method provides a much more efficient, enhanced, and automatic method for generating a sketch notes-based visual summary of the multimedia content, which may include audio podcasts, documents, web pages, and/or the like. The sketch notes-based visual summary of the multimedia content allows learners to customize, edit the tool-generated summary from the video, and allow video navigation from summaries, and quick referencing or future concept revisions. The design and formatting of the sketch notes-based visual summary of the multimedia content maintains chronological, relational, and image properties of concepts discussed in the video by a careful arrangement of sketch cells (comprising salient events) in the generated sketch template. Benefits of the disclosed method and system include automatic visual summarization of educational videos that alternate between presenter and presentation content. Whereas, a number of other known in the art similar video summarization tools focus only on the presentation media, such as chalkboard, blackboard, or lecture slides. The disclosed method and system bring together multiple elements, such as ASR, keyword extraction, automatic sketch query, color selection, template selection, and font assignment, at a single platform. Other benefits of the disclosed method and system include improved accuracy of the visual summary generation and real-time update and navigation through the generated sketch notes-based visual summary of the multimedia content (e.g., educational videos). Massive open online courses (MOOC), research papers, news articles, and the like may be benefited by such a system for auto-generation of a sketch notes-based visual summary of the multimedia content.

The disclosed method and system, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive, such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks, such as LAN, MAN, WAN, and the internet. The computer system facilitates input from a user through input devices accessible to the system through the I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The system and method described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic.” Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above method and system, or the numerous possible variations thereof.

Various embodiments of the method and system for auto-generation of sketch notes-based visual summary of multimedia content have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person having ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for auto-generation of sketch notes-based visual summary of multimedia content, said method comprising:
determining, by a pre-processing engine at an application server, one or more segments of said multimedia content, received from a user-computing device over a communication network, based on one or more transitions in said received multimedia content;
for each of said determined one or more segments:
generating, by said pre-processing engine at said application server, a transcript based on audio content associated with each determined segment;
retrieving, by said pre-processing engine at said application server, a set of reference images, pertaining to each of one or more keywords identified from one or more key phrases in said generated transcript, from a reference image repository based on each of said identified one or more keywords; and
generating, by said pre-processing engine at said application server, a sketch image of each of one or more of said retrieved set of reference images associated with each of said identified one or more keywords; and
rendering, by a sketch note compiler at said application server, said sketch notes-based visual summary of said multimedia content, generated based on at least generated one or more sketch images associated with said determined one or more segments of said multimedia content, on a user interface displayed on a display screen of said user-computing device.

2. The method of claim 1 further comprising receiving, by one or more transceivers at said application server, a request for said sketch notes-based visual summary of said multimedia content from said user-computing device over said communication network.

3. The method of claim 1, wherein a transition from said one or more transitions in said multimedia content corresponds to switching from one or more first events associated with one or more first frames in said multimedia content to one or more second events associated with one or more second frames in said multimedia content.

4. The method of claim 3, wherein said transition is further associated with one or more time stamps of said one or more first frames and said one or more second frames.

5. The method of claim 1 further comprising extracting, by said pre-processing engine at said application server, said one or more key phrases from said generated transcript based on a degree of importance of one or more words in said generated transcript.

6. The method of claim 5 further comprising normalizing, by said pre-processing engine at said application server, said extracted one or more key phrases in said generated transcript to eliminate at least one or more stop words from said extracted one or more key phrases.

7. The method of claim 6, wherein said one or more keywords are identified, by said pre-processing engine at said application server, from said one or more key phrases based on a frequency of occurrence of said one or more keywords in said one or more key phrases associated with said determined one or more segments.

8. The method of claim 1 further comprising performing, by said pre-processing engine at said application server, a first layer processing on each retrieved reference image from said retrieved set of reference images to obtain a first processed image comprising a plurality of colors, wherein said plurality of colors includes at least a major color and a minor color.

9. The method of claim 8 further comprising performing, by said pre-processing engine at said application server, a second layer processing on said each retrieved reference image from said retrieved set of reference images to obtain a second processed image comprising edges of said each retrieved reference image.

10. The method of claim 9, wherein said sketch image is generated, by said pre-processing engine at said application server, based on at least merging of said first processed image and said second processed image.

11. The method of claim 1 further comprising generating, by said sketch note compiler at said application server, a sketch cell, pertaining to each of said determined one or more segments, based on at least a pre-defined object model.

12. The method of claim 11, wherein said sketch notes-based visual summary of said multimedia content is generated based on at least said sketch cell pertaining to each of said determined one or more segments and one or more pre-defined templates.

13. The method of claim 1 further comprising updating, by said sketch note compiler at said application server, said generated sketch notes-based visual summary of said multimedia content, based on one or more input parameters provided by a user via said user-computing device over said communication network.

14. A system for auto-generation of sketch notes-based visual summary of multimedia content, said system comprising:
a pre-processing engine of an application server configured to determine one or more segments of said multimedia content, received from a user-computing device over a communication network, based on one or more transitions in said received multimedia content;
for each of said determined one or more segments:
said pre-processing engine at said application server configured to:
generate a transcript based on audio content associated with each determined segment;
retrieve a set of images, pertaining to each of one or more keywords identified from one or more key phrases in said generated transcript, from an image repository based on each of said identified one or more keywords; and
generate a sketch image of each of one or more of said retrieved set of images associated with each of said identified one or more keywords; and
a sketch note compiler at said application server configured to render sketch notes-based visual summary of said multimedia content, generated based on at least generated one or more sketch images associated with said determined one or more segments of said multimedia content, on a user interface displayed on a display screen of said user-computing device.

15. The system of claim 14, wherein one or more transceivers at said application server are configured to receive a request for said sketch notes-based visual summary of said multimedia content from said user-computing device over said communication network.

16. The system of claim 14, wherein a transition from said one or more transitions in said multimedia content corresponds to switching from one or more first events associated with one or more first frames in said multimedia content to one or more second events associated with one or more second frames in said multimedia content.

17. The system of claim 16, wherein said transition is further associated with one or more time stamps of said one or more first frames and said one or more second frames.

18. The system of claim 14, wherein said pre-processing engine at said application server is configured to extract said one or more key phrases from said generated transcript based on a degree of importance of one or more words in said generated transcript.

19. The system of claim 18, wherein said pre-processing engine at said application server is configured to normalize said extracted one or more key phrases in said generated transcript to eliminate at least one or more stop words from said extracted one or more key phrases.

20. The system of claim 19, wherein said pre-processing engine at said application server is further configured to identify said one or more keywords from said one or more key phrases based on a frequency of occurrence of said one or more keywords in said one or more key phrases associated with said determined one or more segments.

21. The system of claim 14, wherein said pre-processing engine at said application server is further configured to perform a first layer processing on each retrieved image from said retrieved set of images to obtain a first processed image comprising a plurality of colors, wherein said plurality of colors includes at least a major color and a minor color.

22. The system of claim 21, wherein said pre-processing engine at said application server is further configured to perform a second layer processing on said each retrieved image from said retrieved set of images to obtain a second processed image comprising edges of said each retrieved image.

23. The system of claim 22, wherein said pre-processing engine at said application server is further configured to generate said sketch image based on at least merging of said first processed image and said second processed image.

24. The system of claim 14, wherein said sketch note compiler at said application server is further configured to generate a sketch cell, pertaining to each of said determined one or more segments, based on at least a pre-defined object model.

25. The system of claim 24, wherein said sketch notes-based visual summary of said multimedia content is generated based on at least said sketch cell pertaining to each of said determined one or more segments and one or more pre-defined templates.

26. The system of claim 14, wherein sketch note compiler at said application server is further configured to update said generated sketch notes-based visual summary of said multimedia content, based on one or more input parameters provided by a user via said user-computing device over said communication network.

27. A computer program product for use with a computer, said computer program product comprising a non-transitory computer readable medium, wherein said non-transitory computer readable medium stores a computer program code for auto-generation of sketch notes-based visual summary of multimedia content, wherein said computer program code is executable by one or more processors in a computing device to:
determine one or more segments of said multimedia content, received from a user-computing device over a communication network, based on one or more transitions in said received multimedia content;
for each of said determined one or more segments:
generate a transcript based on audio content associated with each determined segment;
retrieve a set of images, pertaining to each of one or more keywords identified from one or more key phrases in said generated transcript, from an image repository based on each of said identified one or more keywords; and
generate a sketch image of each of one or more of said retrieved set of images associated with each of said identified one or more keywords; and
render sketch notes-based visual summary of said multimedia content, generated based on at least generated one or more sketch images associated with said determined one or more segments of said multimedia content, on a user interface displayed on a display screen of said user-computing device.
